(19) United States
(12) Patent Application Publication
(10) Pub. No.: US 2017/0228741 A1
(43) Pub. Date: Aug. 10, 2017

(54) DYNAMIC DISPLAY OF OPEN SOURCE SOFTWARE COMPLIANCE INFORMATION

(71) Applicant: GM Global Technology Operations LLC, Detroit, MI (US)

(72) Inventors: Borce DILEVSKI, Macomb, MI (US); Trevor D. WITTEN, Troy, MI (US); Anthony G. LOBAZA, Bloomfield Hills, MI (US); Russ ELING, LaSalle (CA)

(21) Appl. No.: 15/017,065

(22) Filed: Feb. 5, 2016

(51) Int. Cl. G06Q 30/00; B60R 16/023; G06F 3/14; G06F 21/10

(52) U.S. Cl. CPC G06Q 30/0185; G06F 21/105; B60R 16/023; G06F 3/14; G06F 2221/0773

(57) ABSTRACT

A system and method of displaying open source software (OSS) compliance material in a vehicle. The system and method carryout the following steps: receiving a request to display OSS compliance material; accessing the OSS compliance material from a memory device included within the vehicle electronics; and displaying at least a portion of the OSS compliance material on a visual display in the vehicle. The OSS compliance material may be stored in a central library within the vehicle along with associated metadata, and can be updated as new or upgraded OSS is installed.

### TECHNICAL FIELD

The present invention relates to vehicles and, more particularly, to conveying open source software (OSS) licensing information or material to vehicle owners or other individuals.

### BACKGROUND

Vehicles presently include a wide array of vehicle systems modules (VSMs) or electronic control modules (ECUs) that, either individually or collectively, use OSS. OSS is increasingly present in VSMs or ECUs that control various aspects of vehicle function. In contrast to other types of software, OSS permits a vehicle owner to use or change the software present in the VSMs according to defined terms and conditions.

However, the vehicle owner using or changing the OSS may not be aware of the terms and conditions that he or she needs to comply with. Or the vehicle owner may not readily know where to look to obtain a copy of the licensing terms. Also, the content of the OSS licensing terms can change or OSS can be added to or subtracted from the vehicle. New OSS and related licensing information can be added for a variety of reasons, such as the inclusion of new VSMs or ECUs in the vehicle or the replacement of existing VSMs or ECUs installed on the vehicle. In the past, the vehicle owners looking for compliance information for each OSS may have had to search for the material on different websites, which makes it unlikely that the vehicle owner stays up-to-date with the compliance information and/or reviews the compliance information for all of the OSS on the vehicle.

### SUMMARY

According to an embodiment of the invention, there is provided a method of displaying open source software (OSS) compliance material in a vehicle having vehicle electronics. The method includes: receiving a request to display OSS compliance material; accessing the OSS compliance material from a memory device included within the vehicle electronics; and displaying at least a portion of the OSS compliance material on a visual display in the vehicle.

According to another embodiment of the invention, there is provided a method of displaying open source software (OSS) compliance material in a vehicle that includes receiving OSS compliance material at a programming master module stored on the vehicle; storing the OSS compliance material at one or more vehicle systems modules (VSMs) using the programming master module; accessing the stored OSS compliance material from one or more of the VSMs; and displaying at least a portion of the OSS compliance material on a display in the vehicle.

According to yet another embodiment of the invention, there is provided a method of displaying open source software (OSS) compliance material in a vehicle. The method includes the steps of: (a) accessing at least a portion of OSS compliance material stored at one or more vehicle system modules (VSMs); (b) comparing the accessed OSS compliance material stored at the one or more VSMs with corresponding OSS compliance material stored in an OSS compliance material (OCM) library located at the vehicle; (c) determining that the corresponding OSS compliance material stored in the OCM library is different than the accessed OSS compliance material stored at the one or more VSMs; (d) requesting updated OSS compliance material in response to the determination; (e) receiving the updated OSS compliance material; (f) storing the updated OSS compliance material in the OCM library; and thereafter (g) in response to a request, displaying on a visual display in the vehicle at least some of the updated OSS compliance material stored in the OCM library.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of using the method disclosed herein;

FIG. 2 is a block diagram depicting an embodiment of a portion of the vehicle electronics shown in FIG. 1 that are capable of using the method disclosed herein;

FIG. 3 is a block diagram depicting another embodiment of a portion of the vehicle electronics shown in FIG. 1 that are capable of using the method disclosed herein; and

FIG. 4 is a block diagram depicting an embodiment of method of displaying open source software (OSS) compliance material in a vehicle having vehicle electronics

### DETAILED DESCRIPTION OF THE ILLUSTRATED EMBODIMENTS

The system and method described below locally stores compliance material for open source software (OSS) used at the vehicle where it is also displayed. The amount of OSS loaded onto vehicles is increasing and it may be difficult for vehicle owners to be aware of the terms and conditions under which the software can be used or modified. Often, different OSS packages or products are developed by separate business entities. In the past, if a vehicle owner would like to obtain compliance material for different OSS packages, the vehicle owner would first have to identify the software package, the business entity producing the software package, and then navigate through at least one website to find the compliance material for the OSS used at a vehicle.

Instead of leaving the vehicle owner to identify and navigate websites for compliance material, the vehicle can maintain current versions of compliance material for the OSS used at the vehicle. Upon request, the vehicle can visually display the compliance material for the different OSS used at the vehicle to the vehicle owner or other vehicle occupants. Also, the maintenance of OSS compliance material (OCM) can include determining the OSS used by one or more VSMs or other vehicle electronics and then confirming that the OCM maintained at the vehicle is the most recent version. Depending on the implementation, the OCM can be stored at a central computing device, such as a vehicle telematics unit or a vehicle display, or at VSMs themselves. As will be appreciated from the description below, the OCM can be obtained from a variety of sources, including remote facilities that can wirelessly communicate with the vehicle as well as service centers that provide maintenance, such as oil changes, and other vehicle service.

### Communications System

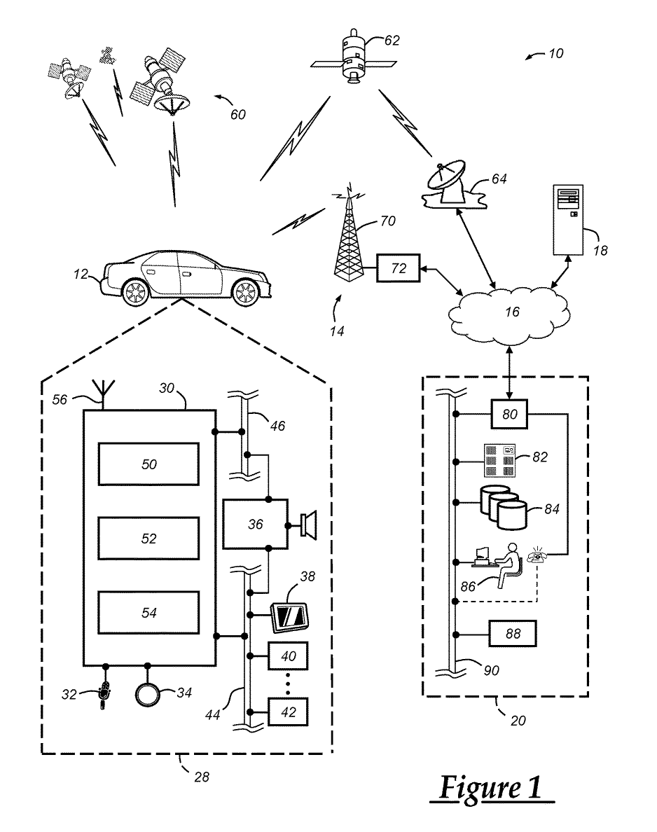

With reference to FIG. 1, there is shown an operating environment that comprises a mobile vehicle communications system 10 and that can be used to implement the methods disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 uses cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. VSM 42 can include a microprocessor, a memory device, input and output terminals, a communications bus, and a housing, as is known in the art. The memory device of the VSM, as well as any other memory device discussed herein, may be a non-transient memory device such as a non-volatile memory device that is capable of maintaining stored data and/or firmware or other software in the device even in the absence of operating power. The term VSM may also be interchangeably referred to as an electronic control unit (ECU). As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above.

Visual display 38 is a VSM that may include a graphics display, such as a touch screen on the instrument panel or a heads-up display reflected off of the windshield, and can be used to provide a multitude of input and output functions. The visual display 38 can include one or more microprocessors, memory devices, communications buses, input output terminals, and/or an antenna as in known to those skilled in the art. The visual display 38 can also be referred to as a center stack module or infotainment head unit (IHU) that can receive content in the form of software, compliance material, or media programming via the entertainment bus 44 or an antenna, similar to the antenna 56 used by the vehicle telematics unit 30, that can carry out short-range wireless communications. The visual display 38 can then present the received media in the vehicle or communicate with the VSMs 42 to communicate software/compliance material with the VSMs 42 or the vehicle telematics unit 30. In some embodiments, the visual display 38 can store OSS and OCM in its own memory device rather than or in addition to sending the OSS/OCM to other portions of the vehicle electronics 28. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data, software, or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

The open source software (OSS) and the OSS compliance materials (OCM) provided to the vehicle may be installed as a part of the initial manufacturing or configuration of the vehicle prior to customer delivery. At least some of the OSS and OCM may be provided subsequently to the vehicle via added or upgraded vehicle system modules (VSMs), or via software or firmware upgrades or just as an OCM data update. This may be done in some implementations by download to the vehicle from a remote computer, such as computer 18 or from a computer in the call center 20. This downloading may be done via the telematics unit 30 over the wireless carrier system 14, and may be initiated at the vehicle, at the call center, or by some other request or backend office process.

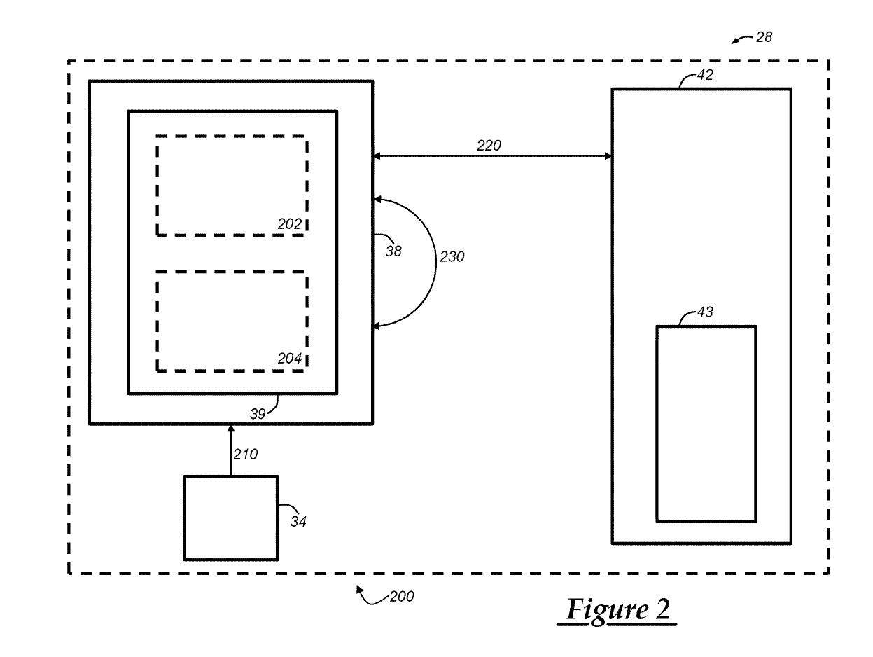

Turning now to FIG. 2, there is shown a portion of the vehicle electronics 28 that can be used to implement an embodiment of a method 200 of displaying open source software (OSS) compliance material (OCM) in the vehicle 12. OSS can include implementations of open firmware or other software applications that are free or open source. Examples of different open firmware applications includes the open source software created by the OpenBIOS project. Generally speaking, OSS includes computer software in which the software creator has granted a user license to a user that makes the OSS available for free use, distribution, or modification by a user. The OCM can be stored as OCM data files and include the content of the license granted to the user for a particular OSS application in text format. The OCM can include a number of data fields that: identify the OSS, the owner of the OSS, the version number of the software, the software issue date, file size, the terms under which the user is able to use the OSS, as well as other information related to the OSS. In some implementations, the identity of the OSS, the owner of the OSS, the version number of the software, the software issue date, and file size can be included in the OCM metadata of individual OCM data files that include the terms of OSS use. The OCM metadata can be included in the OCM data files, or can be saved separately, and the OCM metadata and/or the OCM data files may be included in the OSS, or may be saved as separate files.

File size of the OCM data files can vary depending on the amount of compliance material for presentation in the vehicle 12 and the portion of the vehicle electronics 28 using OSS the OCM describes. For example, certain elements may use more OSS than others and the amount of OCM associated with the larger amount of OSS may be larger as well. The visual display 38 may provide a large number of multimedia functions and as part of these additional features host a larger amount of OSS and OCM than other VSMs 42, such as body control modules and engine control modules that may be responsible for fewer vehicle functions. In one implementation, the OCM file size for OSS used at the visual display 38 can be 1.3 Megabytes (MB) uncompressed and 83 Kilobytes (KB) compressed while another VSM 42 can use an OCM file size of 231 KB uncompressed and 23 KB compressed.

The method 200 may be carried out by the vehicle 12. It begins at step 210 by receiving, at the vehicle 12, a request to display OSS compliance material (OCM). A vehicle occupant (that is, a vehicle user such as a driver or owner) can initiate the request by navigating through one or more menu options that may be shown on the visual display 38 until viewing a selection that offers the vehicle user the option to view OCM. The vehicle user can select the option by depressing the button 34 or, alternatively, selecting the option via a touchscreen on the visual display 38. It should be appreciated that the request to display OCM can be initiated by a source other than a vehicle owner. For example, the visual display 38 can be programmed to periodically display the OCM stored at the vehicle 12 or in response to a change in the content of the OCM stored at the vehicle 12. The addition or subtraction of OSS at the vehicle 12 can change the content of the OCM stored at the vehicle 12. For example, vehicle service given to the vehicle 12 may involve replacing, adding, or subtracting one of the VSMs 42. A change in VSMs 42 may also include a change in the OSS used by the VSMs 42. So, the vehicle 12 may generate a request to display the OCM in response to a change in the OSS used at the vehicle 12 without human initiation. The method 200 proceeds to step 220.

At step 220, OCM is accessed at the vehicle 12 from the VSM 42. This can be implemented in different ways. In one implementation, the vehicle display 38 can query one or more VSMs for OCM files stored at the VSMs 42 in a memory device 43. The OCM files may include one or more OCM libraries; for example, an OCM data library 202 and an OCM metadata library 204 both stored in a memory device 39 at the display 38. The vehicle display 38 can transmit an instruction over the communications bus 44 requesting the VSM 42 send OCM files to the visual display 38. One or more instructions can be transmitted over the communications bus 44 to each VSM 42 in the vehicle 12. The vehicle display 38 may then receive whatever OCM files are stored in the VSMs at the vehicle 12 in response to the instruction(s). In this implementation, the visual display 38 does not store OCM files but instead relies on a distributed storage of the OCM files among the VSMs 42 that, when queried, supply whatever OCM they store. In some implementations, the request to access OCM is generated by the vehicle user. But it should also be appreciated that rather than receiving a request to display the OCM from a vehicle user, the request can be initiated automatically by the vehicle 12 based on some event, such as an ignition on or off. The event can trigger the request to display OCM without action on the part of the vehicle user. For instance, the vehicle display 38 or the VSM 42 can initiate the access of OCM files in response to starting the vehicle 12.

Other implementations are possible. For example, the visual display 38 can maintain OCM files, including OCM data and OCM metadata, for each VSM 42 on the vehicle 12. The OCM metadata library 204 can include, for each OSS and OCM, OSS metadata that includes any one or more of the following types of data: VSM module identifier; VSM module electronic control unit (ECU) identifier; OSS name, OSS version identifier, OSS file information; OCM version identifier, and OCM file information. File information may include information such as the software issue date, file size, checksum, or other information relating to the OSS or OCM file. And a particular version of OSS and OCM may be identified using one or more of these metadata as well as other metadata such as the owner of the OSS. The OCM data library 202 may be used to store the terms and conditions for using the OSS; that is, the actual license terms and/or other compliance material to be displayed for the user. And in some implementations, the content of the OCM presented to a vehicle user can be influenced by the language in which content is displayed at the vehicle 12. The vehicle 12 can offer vehicle users the option to view information on the visual display 38 in one of a number of different languages, such as English, French, Spanish, Chinese, etc. Depending on the identity of the language selected by the vehicle user, different OCM content can be presented to the user. For instance, OCM files can be stored in different languages and an OCM file can be selected based on the language selected at the vehicle 12. When English is selected at the vehicle 12, OCM files including English content can be selected whereas when French is selected, OCM files including French can be selected.

After receiving a request to display OCM, the visual display 38 can access some or all of the OCMs in the OCM data library and display them. Thus, at step 230, the visual display 38 presents at least some portion of the OSS compliance material in the vehicle 12. The visual display 38 extracts content from the OCM files and displays the content allowing the vehicle owner or user to view and read the terms of use for one or more OSS packages. Also, while the method 200 has been described with respect to a visual display 38 storing and/or requesting OCM files from the VSMs 42, a different element with computer processing capabilities could alternatively be substituted for the visual display 38. For example, the actions attributed to the visual display 38 could be carried out using the processor 52 of the vehicle telematics unit 30. After obtaining the OCM files, the vehicle telematics unit 30 could then provide them to the visual display 38 over the communications bus 44. The method 200 then ends.

At times, it may be necessary or desirable to update the OCM files, such as in response to a new VSM being added to the vehicle, or an existing VSM being updated. In this case, the stored OCM files may be replaced with an updated one. In embodiments in which the OCM files are stored solely in the VSMs, the updated OCM files may be accessed when needed directly from the VSMs. In other embodiments in which the OCM files are stored in a database such as the OCM libraries 202, 204, the libraries may be updated by periodic download from a remote computer at a central facility, or downloaded upon request, or can be obtained from the individual VSMs once they are installed or updated, or any combination of these. This may be done periodically, or upon some event, such as a vehicle start (e.g., ignition on). In one embodiment, update of the OCM libraries may be done according to the following update method. This method is used with an embodiment in which the OCM libraries are stored in the visual display 38 itself, but it will be appreciated by those skilled in the art that the libraries may be stored in any other suitable location within the vehicle electronics 28. The update method begins by accessing at least a portion of the OCM stored in one or more of the VSMs. For example, the system can query the VSMs 42 to identify the stored OCM. The query can request OCM files such as the OCM data and/or the OCM metadata stored at each VSM 42. In return, the VSMs 42 can transmit the requested OCM (i.e., the OCM data and/or OCM metadata) to the visual display 38 via the communications bus 44. The visual display 38 can compare the accessed OCM with corresponding OCM stored in the visual display. For example, it may compare some or all of the OCM metadata with corresponding OCM metadata stored at the OCM metadata library in the visual display 38 to determine if they match. When the version of OCM metadata received from the VSMs 42 matches the OCM metadata stored at the visual display 38, it may be decided that the OCM files stored at the VSMs 42 are current and up-to-date. However, if the OCM metadata does not match, the visual display 38 can determine that the OCM files at the VSMs 42 are out-of-date. In that case, the visual display 38 can transmit a request for updated OCM, which request may be sent to the associated VSM (if the updated OCM is stored there) or may be transmitted to a central facility, such as the computer 18, requesting the newest version of the OCM using an identifier or other OCM metadata, and/or identifying the OCM determined to be out-of-date and the version or age of the OCM. The central facility can determine if newer OCM is available and, if so, transmit it to the vehicle 12; otherwise, the central facility can send a message indicating that no newer version is available. Once received, the visual display can update the OCM libraries as needed, by storing the new OCM file(s) in library 202 and/or 204. Thereafter, when a vehicle occupant requests display of the OCM, the updated OCM may be accessed from the OCM data library and display on visual display 38.

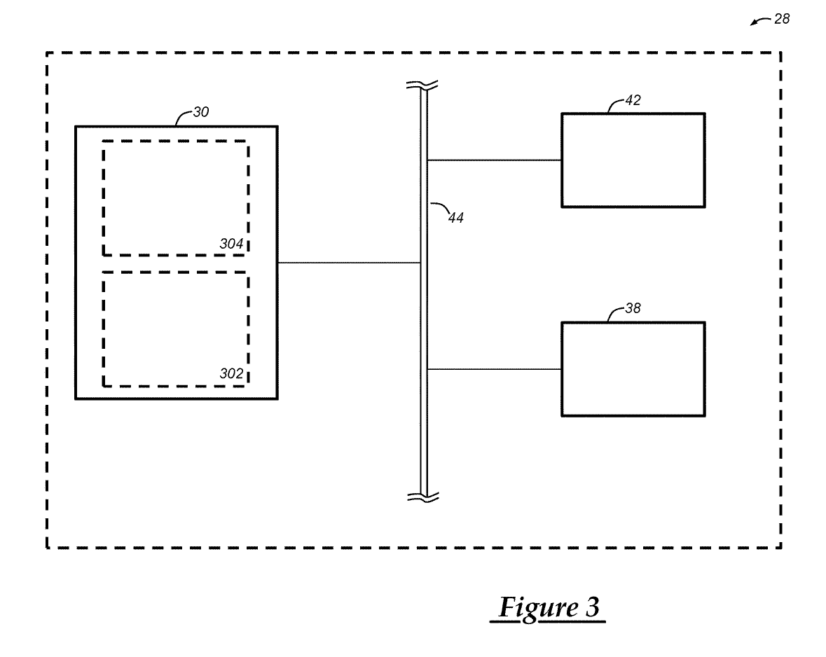

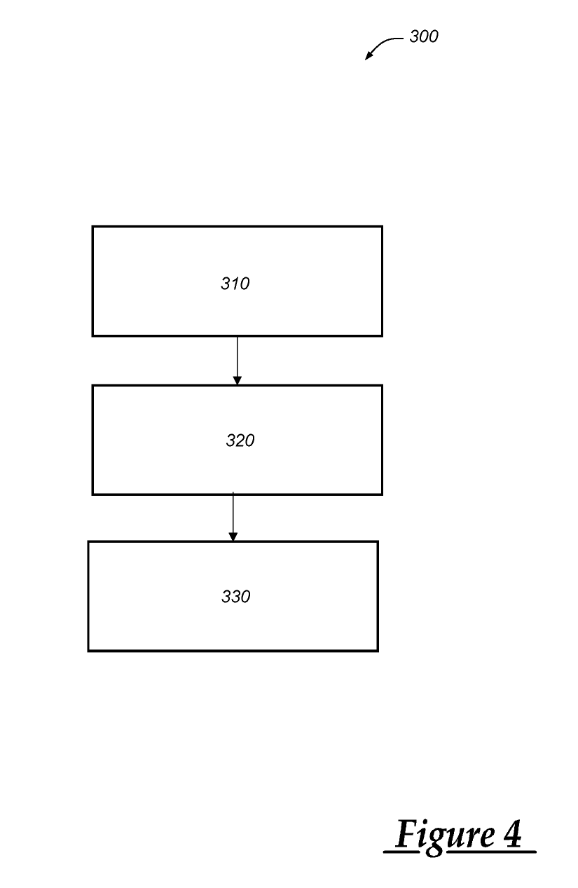

Turning to FIGS. 3-4, there is shown another portion of the vehicle electronics 28 that can be used to implement an embodiment of a method 300 of displaying OSS compliance material in the vehicle 12. The method 300 begins at step 310 by receiving OSS compliance material at a programming master module 302 stored on the vehicle 12. The PMM 302 is a software module that may be tasked with directing the receipt of OCM files from external sources, such as the computer 18 or the service center (not shown), as well as the storage of OCM files on and the access of OCM files from VSMs 42. The PMM 302 can be stored at the vehicle telematics unit 30—as is shown in FIG. 3—or another element in the vehicle 12 that includes computer processing capability and is linked to the communications bus 44. The PMM 302 can act as a gateway module between entities outside of the vehicle 12 and software/hardware within the vehicle 12.

For example, the computer 18 can wirelessly transmit OSS, OCM, or both to the vehicle 12 via the wireless carrier system 14. After receiving OSS and/or OCM data files, the PMM 302 can then determine where in the vehicle 12 the OSS/OCM data files should be stored and transmit the files to the appropriate location. In one implementation, the PMM 302 can receive a VSM identifier in the form of an electronic control unit (ECU) ID along with the incoming OSS/OCM data files that identify the VSM 42 receiving each file. In another implementation, the PMM 302 can store a VSM identity along with all of the OSS associated with each VSM 42 in a firmware directory 304. When the PMM 302 receives OSS/OCM files from an external source, the PMM 302 can query the firmware directory 304 that associates the VSM 42 with OSS files, OCM files, or both. The firmware directory 304 can be maintained as a database or data structure the contents of which may be accessed by the vehicle telematics unit 30 or the visual display 38. The PMM 302 can use the firmware directory 304 to then associate received files with a particular VSM 42 and then transmit the files to the particular VSM 42 over the communications bus 44. In some implementations, the PMM 302 can store the OCM data files centrally instead of sending the files to the VSM 42 for storage. The method 300 proceeds to step 320.

At step 320, the OCM is stored at one or more VSMs 42 using the PMM 302 and can be later accessed for presentation on the visual display 38. After the PMM 302 transmits the OSS or OCM files to the VSMs 42 they are stored in a memory device of the VSMs 42. The method 300 proceeds to step 330. The stored OSS compliance material is accessed from one or more of the VSMs 42 and at least some portion of the OSS compliance material is presented on the visual display 38 in the vehicle 12.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of displaying open source software (OSS) compliance material in a vehicle having vehicle electronics, comprising the steps of:
(a) receiving a request to display OSS compliance material;
(b) accessing the OSS compliance material from a memory device included within the vehicle electronics; and
(c) displaying at least a portion of the OSS compliance material on a visual display in the vehicle.

2. The method of claim 1, wherein the request is received from a vehicle owner.

3. The method of claim 1, wherein the visual display is installed in the vehicle and wherein the method further comprises the step of storing the OSS compliance material at the visual display.

4. The method of claim 1, further comprising the step of storing the OSS compliance material at one or more vehicle system modules (VSMs).

5. The method of claim 1, wherein the OSS compliance material further comprises one or more OSS data files, OSS metadata, or both.

6. The method of claim 1, further comprising the step of receiving the OSS compliance material from a remote facility via a wireless carrier system.

7. The method of claim 1, wherein the memory device is located in a vehicle systems module (VSM) having OSS stored therein.

8. The method of claim 1, wherein the memory device is located in the visual display.

9. The method of claim 1, wherein the OSS compliance material comprises new or updated OSS compliance material that is associated with new or updated OSS, and wherein step (a) further comprises receiving the request in response to installation of the new or updated OSS in the vehicle.

10. The method of claim 1, wherein the vehicle electronics includes a plurality of vehicle system modules having OSS stored therein, and wherein the method further comprises the steps of receiving OSS compliance material for the plurality of VSMs at a programming master module that is a part of the vehicle electronics, and providing the received OSS compliance material to the visual display, wherein the received OSS compliance material is received from the VSMs, or from a remote computer via a vehicle telematics unit that is a part of the vehicle electronics, or from both the VSM and remote computer.

11. A method of displaying open source software (OSS) compliance material in a vehicle, comprising the steps of:
(a) receiving OSS compliance material at a programming master module stored on the vehicle;
(b) storing the OSS compliance material at one or more vehicle systems modules (VSMs) using the programming master module;
(c) accessing the stored OSS compliance material from one or more of the VSMs; and
(d) displaying at least a portion of the OSS compliance material on a display in the vehicle.

12. The method of claim 11, further comprising the step of displaying the OSS compliance material in response to a request received from a vehicle occupant.

13. The method of claim 11, further comprising the step of associating the OSS compliance material with OSS in a firmware directory.

14. The method of claim 11, wherein the OSS compliance material further comprises one or more OSS data files, OSS metadata, or both.

15. The method of claim 11, wherein the OSS compliance material is received from a remote facility via a wireless carrier system.

16. A method of displaying open source software (OSS) compliance material in a vehicle, comprising the steps of:
(a) accessing at least a portion of OSS compliance material stored at one or more vehicle system modules (VSMs);
(b) comparing the accessed OSS compliance material stored at the one or more VSMs with corresponding OSS compliance material stored in an OSS compliance material (OCM) library located at the vehicle;
(c) determining that the corresponding OSS compliance material stored in the OCM library is different than the accessed OSS compliance material stored at the one or more VSMs;
(d) requesting updated OSS compliance material in response to the determination;
(e) receiving the updated OSS compliance material;
(f) storing the updated OSS compliance material in the OCM library; and thereafter
(g) in response to a request, displaying on a visual display in the vehicle at least some of the updated OSS compliance material stored in the OCM library.

17. The method of claim 16, wherein the OCM library includes an OCM metadata library and/or an OCM data library stored at the visual display.

18. The method of claim 16, wherein the OSS compliance material further comprises one or more OSS data files, OSS metadata, or both.

19. The method of claim 18, further comprising the step of receiving the updated OSS compliance material from the remote facility via a wireless carrier system.

20. The method of claim 18, wherein the accessed OSS compliance material (OCM) comprises OSS metadata that includes any one or more of the following types of data: VSM module identifier; VSM module electronic control unit (ECU) identifier; OSS name, OSS version identifier, OSS file information; OCM version identifier, and OCM file information.
